(19) United States
(12) Patent Application Publication
(10) Pub. No.: US 2018/0355655 A1
(43) Pub. Date: Dec. 13, 2018

(54) Window Insulating Kit and Method of Installation

(71) Applicant: Loxcreen Canada Ltd., Mississauga (CA)

(72) Inventors: Dave Matthew, Mississauga (CA); Andrew Reed, Mississauga (CA)

(73) Assignee: Loxcreen Canada Ltd., Mississauga (CA)

(21) Appl. No.: 16/004,314

(22) Filed: Jun. 8, 2018

Related U.S. Application Data
(60) Provisional application No. 62/529,821, filed on Jul. 7, 2017.
(60) Provisional application No. 62/517,577, filed on Jun. 9, 2017.

(51) Int. Cl. E06B 3/28

(52) U.S. Cl. CPC E06B 3/28

(57) ABSTRACT

An insulating kit for a window. A kit includes a frame member in segments secured to a window frame. A window insulating film is attached to the frame members and extends over an opening in the window frame. A segmented cap is mated to the frame member segments and secures the insulating film between the cap and the frame member. The insulating film can be replaced by separating the cap from the frame member, removing and then replacing the film, and then securing the cap to the frame member.

### TECHNICAL FIELD

The present application relates to window insulating films used for weather proofing.

### BACKGROUND OF THE ART

In colder climates, windows may be responsible for substantial energy losses. Indeed, windows often have a lower insulating value that surrounding walls. Moreover, as windows are commonly openable and closable, a path may be formed for drafts. Therefore, insulating film kits have been made available so as to form air spaces inside or outside of a window. Due to the insulating nature of air, such air spaces can substantially increase the insulating factor of a window and provide other benefits, such as protecting against drafts and preventing frost and condensation. However, there is a need to facilitate the installation of such insulating films on windows.

### SUMMARY

It is an aim of the present disclosure to provide a window insulating kit that addresses issues associated with the prior art.

It is a still further aim of the present disclosure to provide a method for installing a window insulating film that addresses installation issues associated with the prior art.

According to a first embodiment, there is a window insulating kit comprising: a window insulating film of transparent polymer; a frame member having an elongated trim body, the frame member sectionable in segments of desired length, and configured to be mounted to a window frame; and an elongated cap sectionable in segments of desired length, and configured to releasably connect to the frame member in a male/female connection, whereby the male/female connection holds captive a panel of the window insulating film between the segments of the elongated cap and of the frame member.

According to a second embodiment, there is a method for installing insulating film on a window frame, comprising: securing frame members on a window frame to form a film-receiving frame around an opening of the window frame; covering the film-receiving frame with a panel of the film such that the panel extends over an opening in the window frame; and capturing the panel of film by mating a cap with the film-receiving frame all around the opening in the window frame.

### DESCRIPTION OF THE DRAWINGS

FIG. 1 is a perspective view of a frame member and cap of a window insulating kit of the present disclosure, for window frame interior mount;

FIG. 2 is a perspective view showing the frame member of FIG. 1 as mounted to a window frame interior;

FIG. 3 is a perspective view of a window insulating kit featuring the frame member of FIG. 1 as mounted to the window frame interior;

FIG. 4 is a perspective view of a frame member and cap of a window insulating kit of the present disclosure, for window frame exterior mount;

FIG. 5 is a perspective view showing the frame member of FIG. 4 as mounted to a window frame exterior, in an exterior mount; and

FIG. 6 is a perspective view of a window insulating kit featuring the frame member of FIG. 4 as mounted to the window frame exterior.

### DETAILED DESCRIPTION

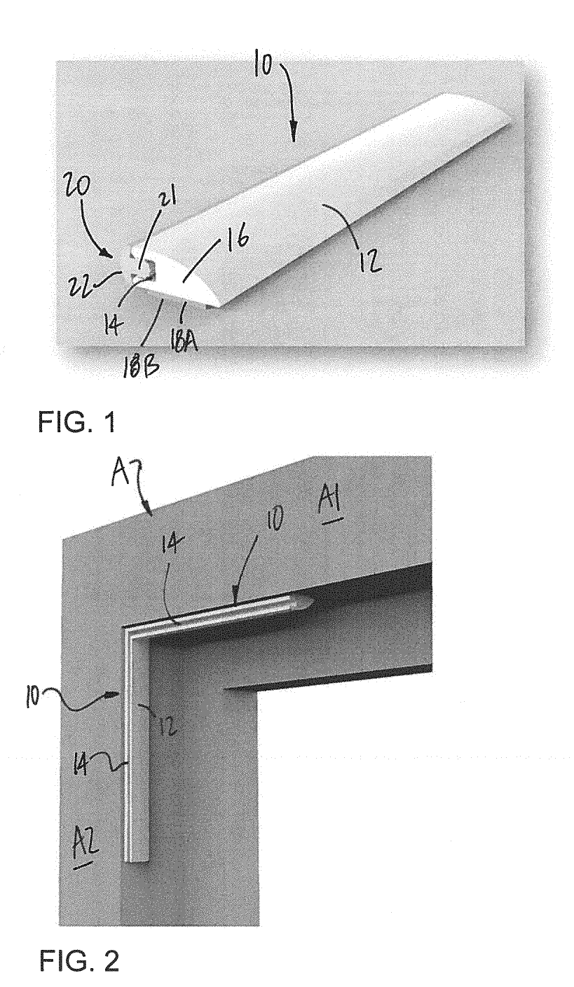

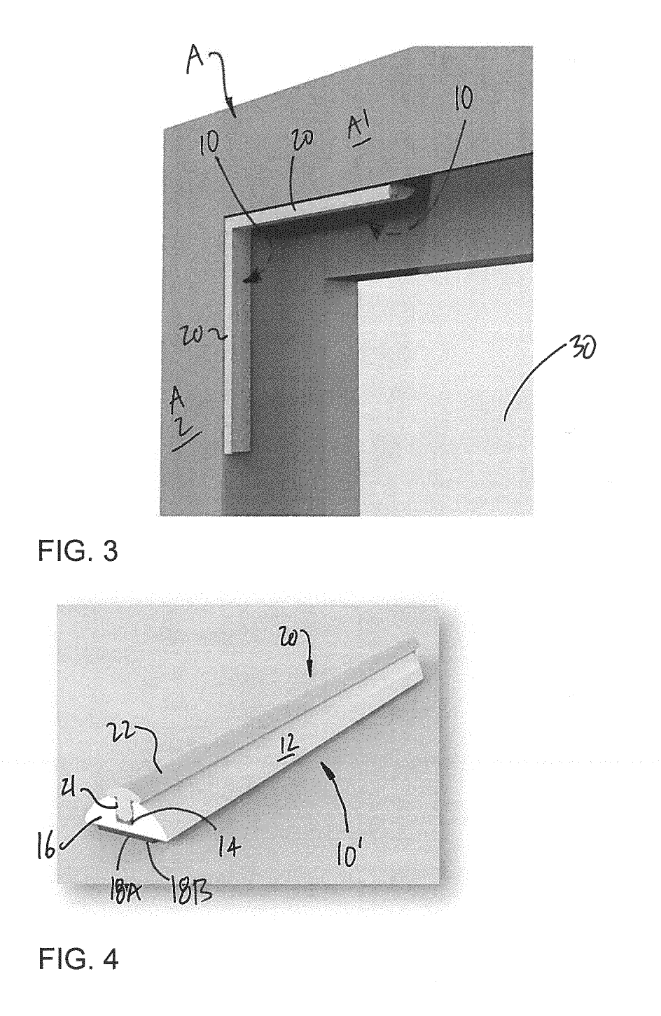

Referring to the drawings and more particularly to FIGS. 1 to 3, there are shown parts of a window insulating kit in accordance with the present disclosure. The window insulating kit of FIGS. 1 to 3 has a frame member 10, a cap 20 and film 30 (FIG. 3):
The frame member 10 is used to form a frame or support interfacing the film 30 to a window frame, in an insulating arrangement. The frame formed of segments of the frame member 10 may be left permanently on the window frame for repeated use.
The cap 20 interacts with the frame member 10 in order to retain the film 30 in a taut condition in the manner shown in FIG. 3.
The film 30 is the insulating film forming a generally air-tight barrier that will form an air pocket acting as an insulator, and reducing air infiltration through the window. The insulating film made of a generally air-tight transparent polymer. The insulating film 10 may have different properties, including that of being as clear and colourless as possible, although it is possible to have colour and/or tint added to the film, including a UV resistant coating or layer. Another contemplated characteristic is its elasticity. Yet another possible characteristic is its capability of shrinking when heated (i.e., shrink wrap). Various materials may be used for the insulating film 10, including vinyl, polyolefin, PVC, polyethylene, polypropylene, to give a few examples of many possible polymers that may be used to form the insulating film 10.

In FIGS. 2 and 3, for context, the window frame is generally shown at A and is the structure that surrounds the window. The window frame may also be known as window casing, window structure, etc. The window frame A has a head A1, jambs A2 on opposed sides and a sill at a bottom. The insulating film 30 will be installed about a peripheral contour of the window frame A, although it is possible to install the insulating film 30 on other parts of the window or window casing. For example, a window structure may be integrally part of the window and may be the structure to which the insulating film 30 is installed. It is also possible to install the insulating film 30 on the inside or the outside of the window.

Referring to FIG. 1, the frame member 10 has an elongated trim body 12, although other expressions may describe the trim body 12, such as elongated member, extrusion, extruded member, etc. The elongated trim body 12 is typically an extrusion, although other methods of fabrication are considered, including a pultrusion. The elongated trim body 12 is typically made of a plastic or a metal. However, the frame member 10 may be available to a user in an indefinite length, and the user of the window insulating kit may be required to cut off segments of the frame member 10. Therefore, the material for the frame member 10 must allow the cutting off of sections in such a way that clean joints are made, for making right-angle assemblies of end-to-end segments of the frame member 10, after 45 degree cuts, for example. The material selected for the frame member 10 may be influenced by the contemplated ease of sectioning parts of the frame member 10. As an example, the frame member 10 may be cutable by scissors. The frame member 10 may also have sufficient resilience to come as a roll, in such a way that the frame member 10 is rolled in elastic deformation, to then be straightened for use.

The elongated trim body 12 has a longitudinal cavity 14 extending along its full length. The longitudinal cavity 14 may have any appropriate cross-section, including a relatively rectangular shape. As shown in FIG. 1, one of the end faces 16 illustrates one possible cross-sectional shape of the elongated trim body 12. The illustrated cross-section is that of a right-angle triangle with a curved hypotenuse, and is well suited to provide a minimalistic look. Other shapes include a rectangular cross-section, a triangular cross-section, among many numerous possibilities. In all possible shapes, the elongated trim body 12 has the longitudinal cavity 14 that forms a concavity in the cross-sectional shape as observed from the end face 16 of FIG. 1. The longitudinal cavity 14 is devised to receive the cap 20 in a male/female arrangement, with the cap 20 received in the longitudinal cavity 14. However, the opposite arrangement is possible as well, with the cap 20 acting as female for connection with the trim body 12, in which case the trim body 12 would have a projecting member or portion.

An adhesive 18A may be provided on a contact surface of the elongated trim body 12. The contact surface is generally flat as it will be applied against a flat surface of the window frame A. The adhesive 18A may be a pressure-sensitive adhesive, a tacky adhesive, etc. The adhesive 18A may be protected by a backing layer 18B that may be peeled off prior to installation. Alternatively, the kit may comprise an adhesive that may be applied onto the contact surface of the elongated trim body 12 or on the receiving surface of the window frame. The illustrated solution of an adhesive 18A pre-applied in plant, for instance with or without a backing layer 18B, is known to be practical.

Referring to FIGS. 1 and 3, the cap is shown at 20, and may have any appropriate shape, including a mushroom cross-section in the manner shown in FIG. 1. Other cross-sectional shapes include a T-shape, etc. In the case in which the cap 20 serves as female connector for being connected to the frame member 10, the cap 20 may have a U-shaped cross section. The cap 20 is typically made of a rubbery material, although other more rigid materials may be used as well. The cap 20 comes in an indefinite length, in similar fashion to the frame member 10, so as to be cut to match the length of the frame member segments 10, for instance with the same instrument as used with the frame member 10.

In the embodiment of FIG. 1, the cap 20 has a base portion 21 that is sized to be snugly received in the longitudinal cavity 14 in the manner shown in FIG. 1, so as to be caught therein and removable by manual force. As film 30 will be sandwiched between the base portion 21 of the cap 20 and the surface of the longitudinal cavity 14, or vice versa, the appropriate dimensions should be taken into consideration to ensure that the film 30 is received therein. According to an embodiment, the base portion 21 has a plurality of elongated ribs, to assist in connecting the cap 20 to the frame member 10, and hold the film 30 captive therebetween. Cap 20 may further comprise a bead head 22 that will be the exposed portion of the cap 20 when installed in the manner shown in FIG. 3. The assembly is configured to be flush with the plane of the window frame exterior such that the bead head 22 of the cap 20 has the appearance of a bead molding, for blended architectural appearance. Moreover, the width of the bead head 22 may match that of the frame member 10 for a generally continuous appearance.

FIGS. 4 to 6 show another embodiment of the window insulating kit, but with the frame members 10′ configured to be mounted to the window frame exterior, in contrast to the embodiment of FIGS. 1-3, in which the frame members 10 are mounted to the window frame interior. Accordingly, like reference numerals will show like elements in FIGS. 1 to 3 and 4 to 6. A notable difference is the shape of the frame member 10′ in the window frame exterior version as observed in FIG. 4. As observed from the end face 16, the frame member 10′ may have a circular segment cross-section shape, although other shapes are considered such as rectangular, square, triangular.

Now that the various components of the window insulating kits have been described, a method of installation is set forth.

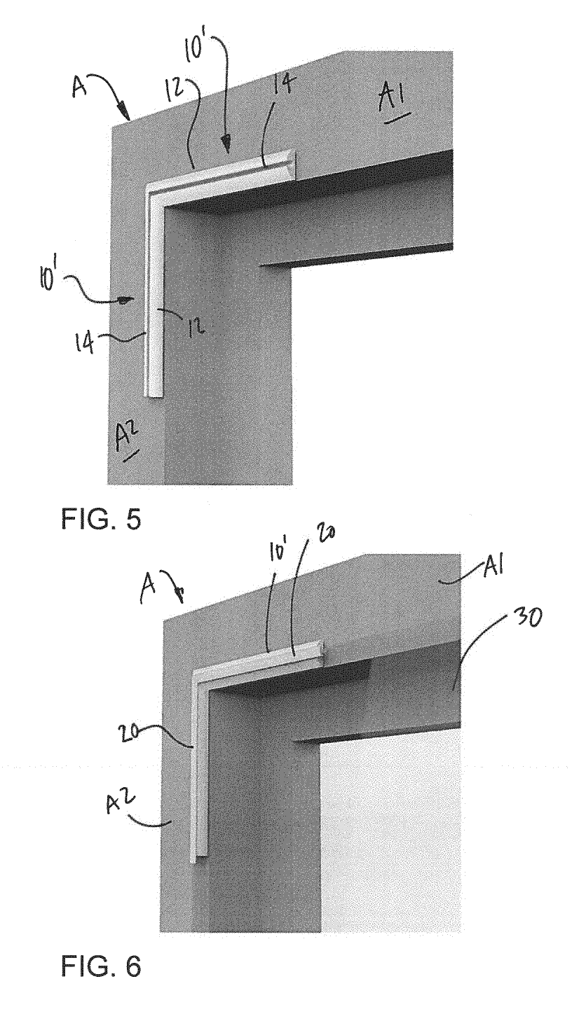

As a first step, the window frame interior/exterior is measured such that a frame member 10/10′ of indefinite length may be cut into segments of appropriate lengths. If the window is rectangular, the segments of the frame members 10/10′ are cut to form 90-degree corners in the manner shown in FIGS. 2 and 5. Once segments of appropriate lengths of the frame member 10/10′ have been cut, the frame members 10/10′ are installed in the window frame interior/exterior to form the frames shown in FIGS. 2 and 3, or FIGS. 5 and 6. It is observed that fragmented frame members 10 are shown in FIGS. 2 and 5 to illustrate the end faces of the frame members. It is however understood that the frame members 10/10′ extend from end to end of the window frame opening. Stated differently, FIGS. 2 and 5 are provided with incomplete frame members 10 for illustrative purposes only.

Once segments of appropriate lengths of the frame member 10 or 10′ have been cut, they may be positioned in the manner shown in FIGS. 2 and 3, or FIGS. 5 and 6. It may be required that the backing layer 18B be peeled off for the adhesive 18A,to be exposed to secure the frame member 10 or 10′ to the surface of the window frame. Alternatively, an adhesive may be applied onto the contact surface of the segments of the frame member 10/10′ or against the window frame receiving surface.

It is required to have segments of the cap 20 of generally similar length as the segments of the frame member 10/10′, whereby the cap 20 may be cut in segments simultaneously with the frame member 10/10′. According to an embodiment, the cap 20 may be assembled in the female-male connection for concurrent section of the frame member 10/10′ and cap 20.

Once a full frame is formed by the frame members 10/10′, the film 30 may be installed. A panel of film 30 of appropriate dimensions is cut. It is expected that the film 30 be cut to a size that exceeds the dimensions of window frame opening, as the cut film 30 may be positioned loosely on the frame of frame members 10/10′. When positioned loosely on the frame of frame members 10/10′, at which point a segment of the cap 20 cut to the appropriate size is pushed into engagement with the frame member 10/10′, with the base portion 21 fitted in the longitudinal cavity 14. In doing so, an edge of the film 30 is held captive therebetween. For practical reasons, it may be desired to start with the top edge of the frame of frame members 10/10′. This step is repeated for the other segments of cap 20 and frame members 10/10′ until the film 30 is surrounded by the caps 20, and held captive by the concurrent action of the frame members 10/10′ and caps 20. At that point, it may be desired to heat the film 30 in order to have it reach a shrinked taut condition. It is also possible to use scissors to remove any excess film on the other side of the cap 20. In doing so, all necessary precautions are taken in order to avoid puncturing the film 30.

When it is required to remove the film 30, for example during the warmers parts of a year in which it is desired to open the window, the various segments of cap 20 may be manually pulled off in order to liberate the film 30 from its engagement with the frame members 10/10′. Alternatively, scissors or a knife may be used to cut the film 30 without removing the cap segments 20. The frame members 10/10′ may remain in place year round. The caps 20 may also remain in the segments of frame member 10/10′ as well in order to preserve the blended architectural appearance. A new film 30 may be added at the next insulating season in order to reinsulate the window by using the already installed frame member 10.

The user therefore derives an advantage from this method, in that the frame members 10 may only need to be installed once for many uses of the window insulating kit. The kit may include indefinite lengths of the frame members 10 or 10′, with an equivalent indefinite length of the cap 20, and with film that may be cut to appropriate dimensions. The kit may also include a cutting tool for sectioning the frame members 10 or 10′ and the cap 20. The kit may also include an adhesive, it not present on the frame members 10 or 10′. As another option, the kit may include pre-cut segments of the frame members 10/10′ as a function of the size of the opening to insulate.

Stated differently, a method for installing the insulating film 30 on the window frame A comprises securing frame members 10/10′ on the window frame 10 to form a film-receiving frame around an opening of the window frame A, covering the film-receiving frame of frame members 10/10′ with a panel of the film 30 such that the panel 30 extends over an opening in the window frame A, and capturing the panel of film 30 by mating a cap 20 with the film-receiving frame 10 all around the opening in the window frame A. The method may further comprise removing the panel of film 30, and covering the film-receiving frame and opening in the window frame with another panel of the film 30, months later. Accordingly, the frame of frame members 10/10′ is reusable.

While the window insulating kit described above is commonly used for the interior of a dwelling, it is contemplated to use the window insulating kit on the exterior of a dwelling as well. In both cases, the insulating film 30 may be a solar film to assist in blocking or filtering out solar rays. In particular, the insulating film 30 may block out UV radiation, or other parts of the light spectrum, as desired. Regardless of the indoor or outdoor use, the method of installation of the insulating film 30 is generally similar.

1. A window insulating kit comprising:
a window insulating film of transparent polymer;
a frame member having an elongated trim body, the frame member sectionable in segments of desired length, and configured to be mounted to a window frame; and
an elongated cap sectionable in segments of desired length, and configured to releasably connect to the frame member in a male/female connection,
whereby the male/female connection holds captive a panel of the window insulating film between the segments of the elongated cap and of the frame member.

2. A method for installing insulating film on a window frame, comprising:
securing frame members on a window frame to form a film-receiving frame around an opening of the window frame;
covering the film-receiving frame with a panel of the film such that the panel extends over an opening in the window frame; and
capturing the panel of film by mating a cap with the film-receiving frame all around the opening in the window frame.

3. The method of claim 2, further comprising removing the panel of film, and covering the film-receiving frame and opening in the window frame with another panel of the film.
